(19) United States
(12) Patent Application Publication
(10) Pub. No.: US 2025/0046543 A1
(43) Pub. Date: Feb. 6, 2025

(54) KEY STRUCTURE FOR KEYBOARD

(71) Applicant: Voyetra Turtle Beach, Inc., White Plains, NY (US)

(72) Inventor: Wei Chuan WANG, New Taipei City (TW)

(73) Assignee: Voyetra Turtle Beach, Inc., White Plains, NY (US)

(21) Appl. No.: 18/723,541

(22) PCT Filed: Dec. 14, 2022
(86) PCT No.: PCT/US2022/081544

§ 371 Date: Jun. 24, 2024

(30) Foreign Application Priority Data
Dec. 23, 2021 (TW) 110215324
Dec. 28, 2021 (CN) 202123327954.8

(51) Int. Cl. H01H 13/7073; H01H 13/10; H01H 13/83

(52) U.S. Cl. CPC H01H 13/7073; H01H 13/10; H01H 13/83

(57) ABSTRACT

A keyboard has a top plate with a socket and a key structure that comprises a lower housing having a base, an upper housing, a pressing shaft and a spring. An annular stopper protrudes above the base. Two engaging elastic arms disposed below opposite sides of the annular stopper protrude below the base. The lower housing engages the socket by means of compressing the two engaging elastic arms. The top plate is sandwiched between the annular stopper and the two engaging elastic arms. The upper housing is assembled above the lower housing, and includes a penetrating opening. The pressing shaft is movably sandwiched between the lower housing and the upper housing. A top end of the pressing shaft penetrates through the penetrating opening. The spring is sandwiched and elastically supported between the lower housing and the pressing shaft. Thereby, the aesthetic appearance of the key structure is improved.

### CROSS-REFERENCE TO RELATED APPLICATIONS

This application claims the benefit of Taiwan Patent Application No. 110215324, filed Dec. 23, 2021 (which issued as Taiwan Patent No. M628085 on Jun. 11, 2022), and Chinese Patent Application No. 202123327954.8, filed Dec. 28, 2021 (which issued as Chinese Patent No. ZL 202123327954.8 on Sep. 9, 2022), which are hereby incorporated herein by reference in their entirety.

### TECHNICAL FIELD

The present utility model relates to a key structure, and in particular to a key structure for a keyboard.

### BACKGROUND ART

As e-sports games become more popular and widespread, the requirements of players for video game equipment specifications have also increased, leading to the emergence of a mechanical keyboard on the market. This mechanical keyboard has mechanical keys with long pressing stroke, precise touch and pressing feel, and long service life.

A traditional mechanical key comprises an upper housing, a lower housing, a pressing shaft, a spring, and a cap. The upper housing and the lower housing are assembled with each other and a cavity is formed inside them. The pressing shaft and the spring are accommodated in the cavity. A top end of the pressing shaft is exposed on the upper housing, the spring is elastically supported between a bottom end of the pressing shaft and the lower housing, and the cap is installed on the top end of the pressing shaft.

However, when the above-mentioned lower housing is installed on the keyboard, a stop block that is located to be latched with the keyboard and exposed on the keyboard is protruded from an outer peripheral edge of the lower housing, and in order to allow the lower housing to be firmly assembled on the keyboard and the upper housing, an outer peripheral wall of the stop block will be formed with protrusions and grooves so as to be matched with the structure of the keyboard or the upper housing. However, the unevenness of the outer peripheral wall of the stop block will lead to the unsightly appearance of the keys, so that it is not easy to attract consumers to buy.

### SUMMARY OF THE UTILITY MODEL

The present utility model provides a key structure for a keyboard, which uses an annular stopper whose outer peripheral wall is not provided with a concave-convex structure, so that the annular stopper presents the form of an annular outer peripheral wall, thereby improving the aesthetic appearance of the key structure.

In an embodiment of the present utility model, the present utility model provides a key structure for a keyboard. The keyboard has a top plate, and the top plate is provided with a socket. The key structure comprises: a lower housing having a base, wherein an annular stopper is protruded above an outer side of the base, two engaging elastic arms disposed below opposite sides of the annular stopper are protruded below the outer side of the base toward a direction of approaching the annular stopper, the lower housing is engaged with the socket by means of compressing the two engaging elastic arms, and the top plate is sandwiched between the annular stopper and the two engaging elastic arms; an upper housing assembled above the lower housing, the upper housing being provided with a penetrating opening; a pressing shaft movably sandwiched between the lower housing and the upper housing, a top end of the pressing shaft penetrating through the penetrating opening; and a spring sandwiched and elastically supported between the lower housing and the pressing shaft.

Optionally, there is a separation space between each of the engaging elastic arms and the base.

Optionally, the bottom of each of the engaging elastic arms is provided with a light-transmitting opening disposed corresponding to the separation spaces, the annular stopper is provided with two through slots corresponding to the two separation spaces, the upper housing is made of light-transmitting plastic material, and the upper housing is extended with two light guide columns penetrating through the two through slots and the two separation spaces.

Optionally, the annular stopper is formed with two second edge segments on outer sides of the two through slots, and two ends of an inner edge of each of the second edge segments have two second thickened portions whose thicknesses gradually increase from the middle of the two through slots toward two sides.

Optionally, the annular stopper is formed with two second edge segments on the outer sides of the two through slots, and the upper housing is further extended with two stop blocks disposed on outer sides of the two light guide columns and capable of stopping at the two second edge segments.

Optionally, each of the engaging elastic arms has a transverse piece extending outward from the base and an oblique elastic piece extending upward from an end of the transverse piece, and the top plate is sandwiched between the annular stopper and the two oblique elastic pieces.

Optionally, each of the oblique elastic pieces is a U-shaped piece or a V-shaped piece.

Optionally, the light-transmitting openings are L-shaped openings provided from the transverse pieces and the transverse pieces.

Optionally, each of the transverse pieces is located gradually further away from the base toward the direction approaching the annular stopper.

Optionally, the annular stoppers each have a square shape, the annular stopper has a pair of first opposite sides and a pair of second opposite sides, and the two engaging elastic arms are disposed below the pair of first opposite sides.

Optionally, the pair of second opposite sides of the annular stopper are provided with two hollowed-out clamping slots, two clamping blocks provided inside the hollowed-out clamping slots are extended from the annular stopper, two undercut hooks are extended from the upper housing, and the undercut hooks are engaged with the hollowed-out clamping slots and mutually latched with the clamping blocks.

Optionally, the annular stopper is formed with two first edge segments on outer sides of the two hollowed-out clamping slots, and two ends of an inner edge of each of the first edge segments have two first thickened portions whose thicknesses gradually increase from the middle of the two hollowed-out clamping slots toward two sides.

Optionally, a ring protrusion is extended from an outer peripheral edge of the upper housing, and the two undercut hooks are molded to extend downward from two sides of the bottom of the ring protrusion.

Optionally, an outer peripheral edge of the ring protrusion is provided inward with two notches located above the two undercut hooks, two protrusions protruding from the top of the annular stopper are extended upward from the two clamping blocks, and the protrusions are embedded into the notches, so that the ring protrusion and the two protrusions together form an annular outer peripheral wall.

Optionally, the base has a bottom wall, a protruding column is extended upward from the bottom wall, and the spring is a coil spring and is sleeved on the protruding column.

Optionally, the key structure further comprises a cap, and the cap is assembled on the top of the pressing shaft and follows the pressing shaft to rise or fall.

On the basis of the above content, compared with the prior art in which the outer peripheral wall of the stop block of the lower housing is provided with a corresponding structure that is engaged with the keyboard and presents unevenness, the present utility model utilizes two engaging elastic arms to be engaged in the socket, so that the annular stopper does not need to be provided with a corresponding structure that is engaged with the keyboard. Therefore, the outer peripheral wall of the annular stopper is not provided with a concave-convex structure, so that the annular stopper presents the form of an annular outer peripheral wall, thereby improving the aesthetic appearance of the key structure.

### BRIEF DESCRIPTION OF DRAWINGS

FIG. 1 is an exploded perspective view of a key structure according to the present utility model.

FIG. 2 is a perspective assembly view of the key structure according to the present utility model.

FIG. 3 is a cross-sectional assembly view of the key structure according to the present utility model.

FIG. 4 is a perspective view of the key structure according to the present utility model in a use state.

FIG. 5 is a perspective view of the key structure according to the present utility model in another use state.

FIG. 6 is a cross-sectional view of the key structure according to the present utility model in the use state.

FIG. 7 is an exploded perspective view of another embodiment of the key structure according to the present utility model.

### In the Figures:

10: key structure; 1: lower housing; 11: base; 111: bottom wall; 112: protruding column; 12: annular stopper; 121: through slot; 122: hollowed-out clamping slot; 123: clamping block; 124: protrusion; 125: first edge segment; 126: first thickened portion; 127: second edge segment; 128: second thickened portion; 13: engaging elastic arm; 131: light-transmitting opening; 132: transverse piece; 133: oblique elastic piece; 2: upper housing; 21: penetrating opening; 22: ring protrusion; 221: undercut hook; 222: notch; 23: light guide column; 24: stop block; 3: pressing shaft; 4: spring; 5: cap; s: separation space; 100: keyboard; 101: top plate; 102: socket; 103: bottom plate; and 200: light-emitting source.

### DETAILED DESCRIPTION OF PREFERRED EMBODIMENTS

The present utility model will be further described below in conjunction with accompanying drawings and specific embodiments, so that the present utility model can be better understood and can be implemented by a person skilled in the art, but the embodiments given are not intended to limit the present utility model.

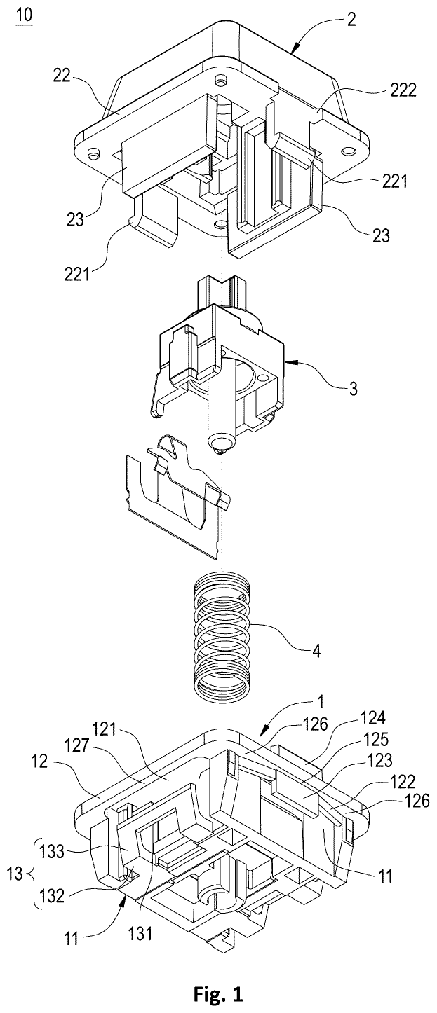

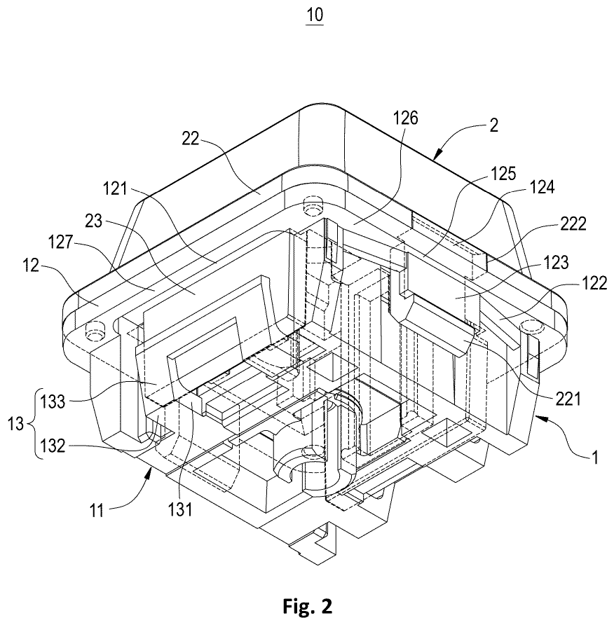

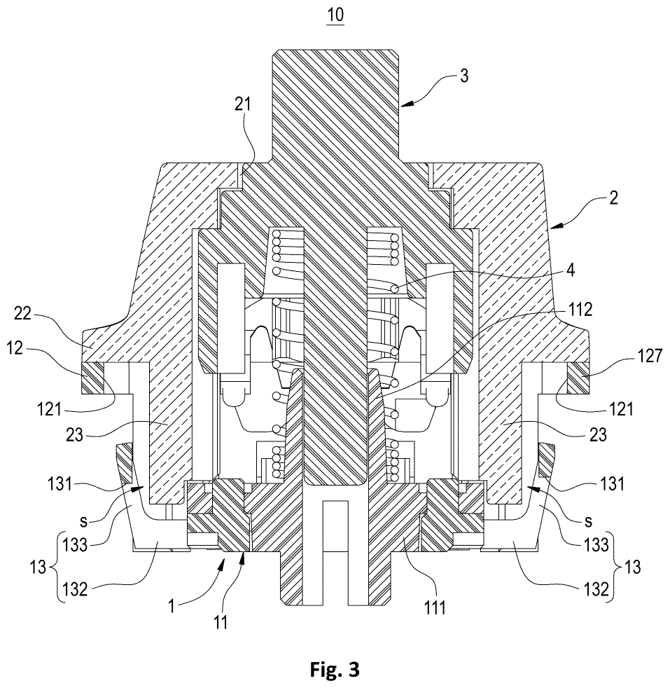

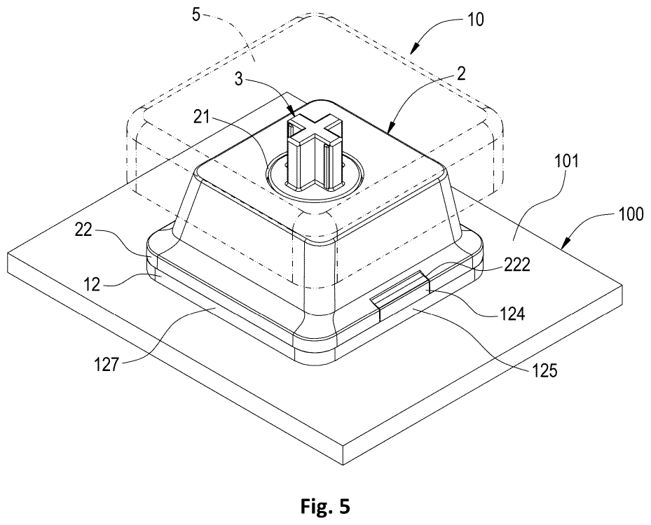

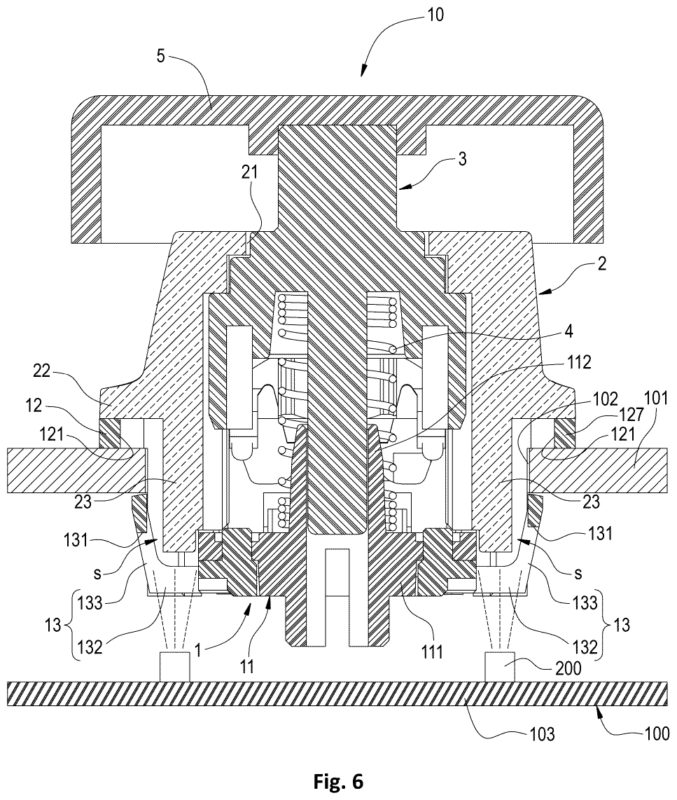

Referring to FIGS. 1 to 6, the present utility model provides a key structure for a keyboard. This key structure 10 mainly comprises a lower housing 1, an upper housing 2, a pressing shaft 3, and a spring 4.

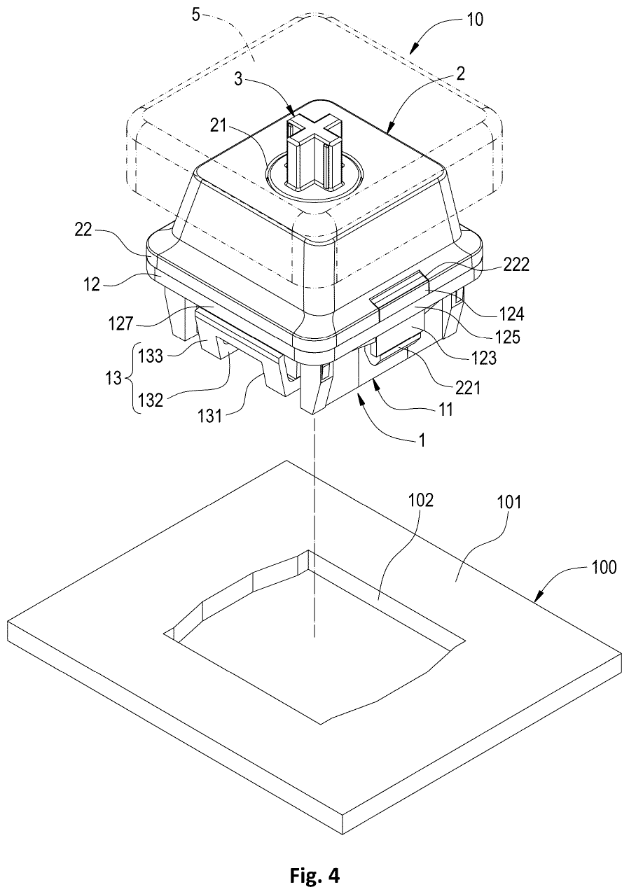

As shown in FIGS. 4 to 6, the key structure 10 according to the present utility model is used for a keyboard base 100. The keyboard 100 has a top plate 101, and the top plate 101 is provided with one or several sockets 102. The keyboard 100 further has a bottom plate 103 disposed below the top plate 101, and several light-emitting sources 200 are mounted on the bottom plate 103. Each light-emitting source 200 in this embodiment is a light-emitting diode (LED), but it is not limited thereto.

As shown in FIGS. 1 to 6, the lower housing 1 has a base 11. The interior of the base 11 has a bottom wall 111. A protruding column 112 is extended upward from the bottom wall 111. An annular stopper 12 is protruded above an outer side of the base 11, two engaging elastic arms 13 disposed below opposite sides of the annular stopper 12 are protruded below the outer side of the base 11 toward a direction of approaching the annular stopper 12. There is a separation space s between each of the engaging elastic arms 13 and the base 11.

When the lower housing 1 is inserted into the socket 102 from the top of the top plate 101, the lower housing 1 can be engaged with the socket 102 by being compressed toward the separation space s by the two engaging elastic arms 13, so that the top plate 101 is sandwiched and positioned between the annular stopper 12 and the two engaging elastic arms 13.

A detailed description is as follows. The bottom of each engaging elastic arm 13 is provided with a light-transmitting opening 131 disposed corresponding to the separation spaces s, and each engaging elastic arm 13 has a transverse piece 132 extending outward from the base 11 and an oblique elastic piece 133 extending upward from an end of the transverse piece 132. The top plate 101 is sandwiched between the annular stopper 12 and the two oblique elastic pieces 133, and the annular stopper 12 is provided with two through slots 121 disposed corresponding to the separation spaces s. The light-transmitting openings 131 are L-shaped openings provided from the transverse pieces 132 and the transverse pieces 132, and each oblique elastic piece 133 is a U-shaped piece, but they are not limited to those shapes.

In addition, each transverse piece 132 is gradually away from the base 11 towards the direction of approaching the annular stopper 12, so that when the lower housing 1 is inserted into the socket 102 from the top of the top plate 101, the transverse pieces 132 are easily compressed towards the separation spaces s.

Further, the annular stoppers 12 each have a square shape. The annular stopper 12 has a pair of first opposite sides and a pair of second opposite sides. The two engaging elastic arms 13 are disposed below the pair of first opposite sides, and the pair of second opposite sides are provided with two hollowed-out clamping slots 122. Two clamping blocks 123 provided inside the hollowed-out clamping slots 122 are extended from the annular stopper 12, and two protrusions 124 protruding from the top of the annular stopper 12 are extended upward from the two clamping blocks 123.

The annular stopper 12 is formed with two first edge segments 125 on outer sides of the two hollowed-out clamping slots 122, the annular stop 12 is formed with two second edge segments 127 on the outer sides of the two through slots 121, two ends of an inner edge of each first edge segment 125 have two first thickened portions 126 whose thicknesses gradually increase from the middle of the hollowed-out clamping slots 122 to two sides, thereby improving the structural strength of the first edge segments 125.

As shown in FIGS. 1 to 6, the upper housing 2 is assembled above the lower housing 1. The upper housing 2 is provided with a penetrating opening 21, and two undercut hooks 221 are extended from the upper housing 2. The undercut hooks 221 are engaged with the hollowed-out clamping slots 122, and are mutually latched with the clamping blocks 123.

A further description is as follows. A ring protrusion 22 is extended from an outer peripheral edge of the upper housing 2. The two undercut hooks 221 are molded to extend downward from two sides of the bottom of the ring protrusion 22, and two notches 222 located above the two undercut hooks 221 are provided inward on an outer peripheral edge of the ring protrusion 22. The protrusions 124 are embedded into the notches 222, so that the ring protrusion 22 and the two protrusions 124 together form an annular outer peripheral wall.

In addition, the upper housing 2 is made of a light-transmitting plastic material, and the upper housing 2 is extended with two light guide columns 23. The two light guide columns 23 penetrate through the two through slots 121 and the two separation spaces s, and are disposed opposite to the light-emitting sources 200, so that the light from the light-emitting sources 200 is irradiated to the two light guide columns 23 through the two light-transmitting openings 131, and the two light guide columns 23 guide the light from the light-emitting sources 200 to the upper housing 2.

As shown in FIGS. 1 and 3 to 6, the pressing shaft 3 is movably sandwiched between the lower housing 1 and the upper housing 2, and a top end of the pressing shaft 3 penetrates through the penetrating opening 21.

As shown in FIGS. 1, 4 and 6, the spring 4 is sandwiched and elastically supported between the lower housing 1 and the pressing shaft 3. The spring 4 of this embodiment is a coil spring and is sleeved on the protruding column 112, but the spring is not limited to such specifications.

As shown in FIGS. 4 to 8, the key structure 10 according to the present utility model further comprises a cap 5. The cap 5 is assembled on the top of the pressing shaft 3, and the cap 5 follows the pressing shaft 3 to rise or fall.

As shown in FIGS. 4 to 6, a use state of the key structure 10 according to the present utility model is that the lower housing 1, the upper housing 2, the pressing shaft 3 and the spring 4 are used to be assembled with each other, and then the lower housing 1 is compressed toward the separation spaces s by the two engaging elastic arms 13 to be engaged with the socket 102, so that the lower housing 1 can be firmly assembled on the top plate 101. Thereby, compared with the prior art in which the outer peripheral wall of the stop block of the lower housing is provided with a corresponding structure that is engaged with the keyboard and presents unevenness, the present utility model utilizes the two engaging elastic arms 13 to be engaged in the socket 102, so that the annular stopper 12 does not need to be provided with a corresponding structure that is engaged with the keyboard. Therefore, the outer peripheral wall of the annular stopper 12 is not provided with a concave-convex structure, so that the annular stopper 12 presents the form of an annular outer peripheral wall, thereby improving the aesthetic appearance of the key structure 10.

Further, two protrusions 124 are extended from the annular stopper 12, and two notches 222 located above the two undercut hooks 221 are provided inward on an outer peripheral edge of the ring protrusion 22. The protrusions 124 are embedded into the notches 222, so that the ring protrusion 22 and the two protrusions 124 together present the form of an annular outer peripheral wall, thereby improving the aesthetic appearance of the key structure 10.

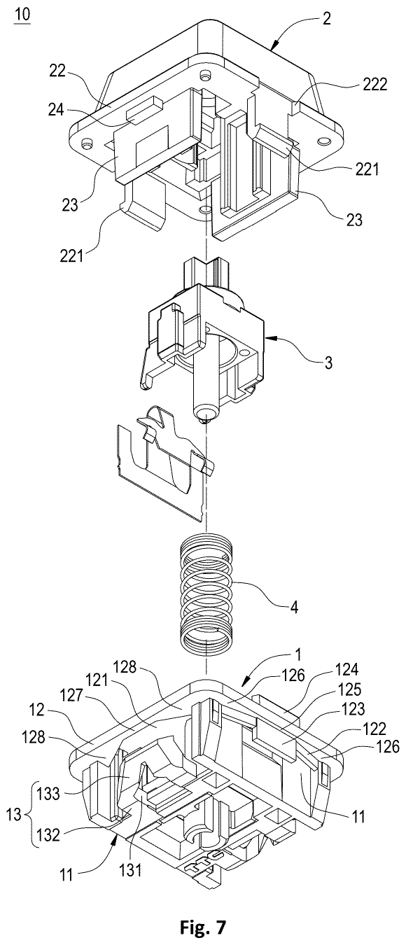

Please refer to FIG. 7, which is another embodiment of the key structure 10 according to the present utility model. The embodiment of FIG. 7 is substantially the same as the embodiment of FIGS. 1 to 6, and is different from the embodiment of FIGS. 1 to 6 in that the lower housing 1 and the upper housing 2 have different partial structures.

A detailed description is as follows. Two ends of an inner edge of each second edge segment 127 of this embodiment have two second thickened portions 128 whose thicknesses gradually increase from the middle of the through slots 121 toward two sides, and the upper housing 2 is further extended with two stop blocks 24 disposed outside the two light guide columns 23 and capable of stopping at the two second edge segments 127, thereby improving the structural strength of the second edge segments 127.

In addition, each oblique elastic piece 133 of this embodiment is a V-shaped piece. Compared with each oblique elastic piece 133 of FIG. 1 being a U-shaped piece, it is easier to open a mold for the V-shaped piece, so that the lower housing 1 has the advantage of convenient mold opening.

The embodiments described above are only preferred embodiments for fully illustrating the present utility model, and the scope of protection of the present utility model is not limited thereto. Equivalent substitutions or transformations made by a person skilled in the art on the basis of the present utility model are all within the scope of protection of the present utility model. The scope of protection of the present utility model is subject to the claims.

1. A key structure for a keyboard, the keyboard comprising a top plate, and the top plate being comprising a socket, wherein the key structure comprises:
a lower housing having comprising a base, wherein an annular stopper is protruded above an outer side of the base, two engaging elastic arms disposed below opposite sides of the annular stopper are protruded below the outer side of the base toward a direction of approaching the annular stopper, the lower housing engages with the socket by compressing the two engaging elastic arms, and the top plate is disposed between the annular stopper and the two engaging elastic arms;
an upper housing disposed above the lower housing, the upper housing comprising a penetrating opening;
a pressing shaft movably disposed between the lower housing and the upper housing, a top end of the pressing shaft penetrating through the penetrating opening; and
a spring elastically supported between the lower housing and the pressing shaft.

2. The key structure of claim 1, wherein the key structure further comprises a separation space between each of the engaging elastic arms and the base.

3. The key structure of claim 2, wherein bottoms of the engaging elastic arms are provided with a light-transmitting opening, the annular stopper comprises two through slots corresponding to the separation spaces, the upper housing comprises a light-transmitting plastic material and two light guide columns extending through the two through slots and the two separation spaces.

4. The key structure of claim 3, wherein the annular stopper comprises two second edge segments on outer sides of the two through slots, and two ends of an inner edge of each of the second edge segments comprise two second portions whose thicknesses gradually increase from a central portion of the two through slots toward two sides.

5. The key structure of claim 3, wherein the annular stopper comprises two second edge segments on the outer sides of the two through slots, and the upper housing further extends with two stop blocks disposed on outer sides of the two light guide columns.

6. The key structure of claim 3, wherein each of the engaging elastic arms comprises a transverse piece extending outward from the base and an oblique elastic piece extending upward from an end of the transverse piece, and the top plate is disposed between the annular stopper and the two oblique elastic pieces.

7. The key structure of claim 6, wherein each of the oblique elastic pieces is a U-shaped piece or a V-shaped piece.

8. The key structure of claim 6, wherein the light-transmitting openings are L-shaped openings provided from the transverse pieces.

9. The key structure of claim 6, wherein each of the transverse pieces is located gradually farther away from the base toward the direction approaching the annular stopper.

10. The key structure of claim 1, wherein the annular stoppers each have a square shape, the annular stopper comprises a pair of first opposite sides and a pair of second opposite sides, and the two engaging elastic arms are disposed below the pair of first opposite sides.

11. The key structure of claim 10, wherein the pair of second opposite sides of the annular stopper comprise two hollowed-out clamping slots, two clamping blocks inside the hollowed-out clamping slots extend from the annular stopper, two undercut hooks extend from the upper housing, and the undercut hooks are engaged with the hollowed-out clamping slots and mutually latched with the clamping blocks.

12. The key structure of claim 11, wherein the annular stopper is formed with two first edge segments on outer sides of the two hollowed-out clamping slots, and two ends of an inner edge of each of the first edge segments comprise two first thickened portions whose thicknesses gradually increase from a central portion of the two hollowed-out clamping slots toward two sides.

13. The key structure of claim 11, wherein a ring protrusion is extended from an outer peripheral edge of the upper housing, and the two undercut hooks are molded to extend downward from two sides of a bottom of the ring protrusion.

14. The key structure of claim 13, wherein an outer peripheral edge of the ring protrusion comprises two notches located above the two undercut hooks, two protrusions protruding from the top of the annular stopper are extended upward from the two clamping blocks, and the protrusions are embedded into the notches, so that the ring protrusion and the two protrusions together form an annular outer peripheral wall.

15. The key structure of claim 1, wherein the base comprises a bottom wall, a protruding column is extended upward from the bottom wall, and the spring is a coil spring and is sleeved on the protruding column.

16. The key structure of claim 1, further comprising a cap disposed on top of the pressing shaft and follows the pressing shaft to rise or fall.
